(19) United States
(12) Patent Application Publication
(10) Pub. No.: US 2014/0050290 A1
(43) Pub. Date: Feb. 20, 2014

(54) METHOD OF CONSTRUCTING PSEUDO HOT PIN POWER DISTRIBUTION USING IN-CORE DETECTOR SIGNAL-BASED PLANAR RADIAL PEAKING FACTORS IN CORE OPERATING LIMIT SUPERVISORY SYSTEM

(71) Applicant: KEPCO NUCLEAR FUEL CO., LTD., (US)

(72) Inventors: Young Ho PARK, Daejeon (KR); Young Baek KIM, Daejeon (KR); Jae Kyu LEE, Daejeon (KR); Kyung Woo SHIM, Daejeon (KR)

(73) Assignee: KEPCO NUCLEAR FUEL CO., LTD., Daejeon (KR)

(21) Appl. No.: 13/859,364

(22) Filed: Apr. 9, 2013

(30) Foreign Application Priority Data
Aug. 17, 2012 (KR) 10-2012-0089916

(51) Int. Cl. G21C 17/108

(52) U.S. Cl. CPC G21C 17/108
USPC 376/254

(57) ABSTRACT

Disclosed herein is a method for constructing a pseudo hot pin power distribution using in-core detector signal-based planar radial peaking factors in a Core Operating Limit Supervisory System (COLSS). The method includes defining a planar radial peaking factor F_{xy}^{K} based on in-core detector signals in the COLSS, and expanding the planar radial peaking factor F_{xy}^{K} so that the planar radial peaking factor F_{xy}^{K} is suitable for a number of nodes of the COLSS. The planar radial peaking factor F_{xy}^{K} is calculated only for the in-core detector signals using a preset equation, rather than by using table lookup.

### BACKGROUND OF THE INVENTION

1. Field of the Invention

The present invention relates generally to a method of constructing a pseudo hot pin power distribution using in-core detector signal-based planar radial peaking factors in a Core Operating Limit Supervisory System (COLSS) and, more particularly, to a technology for calculating a pseudo hot pin power distribution to estimate the high-temperature thermal conditions of a digital COLSS.

2. Description of the Related Art

A COLSS that determines the status of a core in real time or using stored data is installed in a Korea Standard Power Plant, which is loaded with 177 nuclear fuel assemblies, and its succeeding nuclear reactors.

A COLSS functions to enable an operator to accurately detect the status of a core based on a variety of detector information and calculation results and particularly to provide a warning if there is the possibility of a shut-down. In the case of a normal operation, a COLSS intensively provides information about an operating margin.

Recently, in order to improve the rate of the operation and use of a nuclear power plant, a variety of research and development has been conducted. A plurality of prior art documents, including Korean Patent Application Publication No. 10-2001-39442 entitled “Method of Calculating Axial Power Distribution using Virtual Nuclear In-core Detectors in Core Monitoring System,” discloses such research and development.

Korean Patent Application Publication No. 10-2001-39442 discloses a method of calculating a power distribution using virtual nuclear in-core detectors in order to improve the accuracy of the calculation of the axial power distribution of a COLSS, including a first step of obtaining the configuration and power information of virtual nuclear in-core detectors; and a second step of calculating the axial power distribution based on the power information.

However, the power distribution is inappropriately calculated and so the variables that are very important to operation and which belong to operational information provided by the COLSS are overestimated, so that there arises the problem of imposing a restriction on the operation of a nuclear reactor notwithstanding that the operating margin is sufficient. Furthermore, it is difficult to accurately calculate the power distribution.

### SUMMARY OF THE INVENTION

Accordingly, the present invention has been made keeping in mind the above problems occurring in the prior art, and an object of the present invention is to define a planar radial peaking factor F_{xy}^{K} based on in-core detector signals and to then calculate a pseudo hot pin power distribution in a COLSS.

In order to accomplish the above object, the present invention provides a method for constructing a pseudo hot pin power distribution using in-core detector signal-based planar radial peaking factors in a Core Operating Limit Supervisory System (COLSS), the method including defining a planar radial peaking factor F_{xy}^{K} based on in-core detector signals in the COLSS, and expanding the planar radial peaking factor F_{xy}^{K} so that the planar radial peaking factor F_{xy}^{K} is suitable for a number of nodes of the COLSS; wherein the planar radial peaking factor F_{xy}^{K} is calculated only for the in-core detector signals using Equation 6, rather than by using table lookup:

$${F}_{xy}^{K} ≅ {max}_{1 , N det} [ {[ \frac{1 \text{-} Pin}{RPF} ]}_{IK} \times \frac{PHI ( I , K )}{{\sum }_{ I = 1}^{Ndet} PHI ( I , K ) / N det} ] for K - 1 , 5 \\ where \\ N det = No . of in \text{-} core detector thimble ( = 45 for OPR 1000 ) \\ PHI ( I , K ) = assembly power in the instrumented string I level K \\ \begin{matrix} {[ \frac{1 \text{-} Pin}{RPF} ]}_{IK} = CECOR 1 \text{-} pin correlation factor ( '' 1 \text{-} pin factor '' ) \\ = ( maximum pin power in assembly \\ I level K power in core ) divided by the relative \\ power fraction for assembly I at node K\end{matrix} \qquad ( 6 )$$

The planar radial peaking factor may be calculated in real time based on the relationships between axial locations of the in-core detectors and nodes of the COLSS using Equation 7:

{PLRAD(J), J=1,4}=F_{xy}^{K} (K=1)

{PLRAD(J), J=5,8}=F_{xy}^{K} (K=2)

{PLRAD(J), J=9,12}=F_{xy}^{K} (K=3)

{PLRAD(J), J=13,16}=F_{xy}^{K} (K=4)

{PLRAD(J), J=17,20}=F_{xy}^{K} (K=5) (7)

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing comparisons between planar radial peaking factor values and pseudo hot pin power distributions when a method for constructing a pseudo hot pin power distribution using in-core detector signal-based planar radial peaking factors in a COLSS according to the present invention has been applied to cycle 13 of unit 3 of the Yeonggwang nuclear power plant and the burn-up is BU=0.0 [MWD/MTU];

FIG. 2 is a diagram showing comparisons between planar radial peaking factor application values and pseudo hot pin power distributions when the method for constructing a pseudo hot pin power distribution using in-core detector signal-based planar radial peaking factors in a COLSS according to the present invention has been applied to cycle 13 of unit 3 of the Yeonggwang nuclear power plant and the burn-up is BU=8571.0 [MWD/MTU];

FIG. 3 is a diagram showing comparisons between planar radial peaking factor application values and pseudo hot pin power distributions when the method for constructing a pseudo hot pin power distribution using in-core detector signal-based planar radial peaking factors in a COLSS according to the present invention has been applied to cycle 13 of unit 3 of the Yeonggwang nuclear power plant and the burn-up is BU=15481.0 [MWD/MTU];

FIG. 4 is a diagram showing Fq errors calculated using three codes, that is, COLSIM, LIVE_COLSIM and SP_CCR_COLSIM, based on the method for constructing a pseudo hot pin power distribution using in-core detector signal-based planar radial peaking factors in a COLSS according to the present invention;

FIG. 5 is a diagram showing DNBR POL errors calculated using three codes, that is, COLSIM, LIVE_COLSIM and SP_CCR_COLSIM, based on the method for constructing a pseudo hot pin power distribution using in-core detector signal-based planar radial peaking factors in a COLSS according to the present invention;

FIG. 6 is a diagram showing the results of the estimation of overall uncertainty (the most conservative results of UNCERT and EPOL) based on the method for constructing a pseudo hot pin power distribution using in-core detector signal-based planar radial peaking factors in a COLSS according to the present invention;

FIG. 7 is a diagram showing comparisons between the Fq and DNBR thermal margins of the cycle 13 of unit 3 of the Yeonggwang nuclear power plant based on the method for constructing a pseudo hot pin power distribution using in-core detector signal-based planar radial peaking factors in a COLSS according to the present invention;

FIG. 8 is a diagram showing comparisons between the thermal margins based on the method for constructing a pseudo hot pin power distribution using in-core detector signal-based planar radial peaking factors in a COLSS according to the present invention and the thermal margins based on the “simplified CECOR implemented COLSIM” of the initial cores of units 3 and 4 of the Yeonggwang nuclear power plant;

FIG. 9 is a flowchart showing the method for constructing a pseudo hot pin power distribution using in-core detector signal-based planar radial peaking factors in a COLSS according to the present invention; and

FIG. 10 is a diagram showing the relationships between the axial locations of in-core detectors and the nodes of the COLSS in the method for constructing a pseudo hot pin power distribution using in-core detector signal-based planar radial peaking factors in a COLSS according to the present invention.

### DESCRIPTION OF THE PREFERRED EMBODIMENTS

Based on the principle that an inventor can appropriately define the meanings of terms and words to best describe his/her own invention, the terms and words used herein should be interpreted to have meanings and concepts that conform to the spirit of the present invention. Furthermore, it should be noted that detailed descriptions of well-known functions and constructions which have been deemed to make the gist of the present invention unnecessarily vague will be omitted hereinafter.

1. Background

The most important feature of a digital COLSS installed in light-water nuclear reactors OPR1000 and APR1400 that are operating in Korea is that a pseudo hot pin power distribution is used to directly estimate high-temperature thermal conditions.

That is, a true hot pin power distribution can be conservatively estimated using such a pseudo hot pin power distribution even when an overall 3D core power distribution is not known in detail.

This stems from the fact that an on-line COLSS does not have the computational capability to perform 3D analysis, and also comes from the fact that the conservativeness of the finally calculated DNBR and LHR values can be mathematically proven using the pseudo hot pin power distribution.

In the calculation of a power distribution, an average in-core axial power distribution and the 3D power distribution of a virtual hot channel are calculated using in-core detector signals and the group locations of a control rods, and a deviation value. The 3D power distribution is calculated by multiplying an average in-core axial power distribution by a planar radial peaking factor based on the location of a control rod, rather than by calculating the actual power distribution. Additionally, the power distribution is adjusted using azimuthal tilts in blocks T, U and W.

The pseudo hot pin power distribution is defined by the following Equation 1:

$${P}_{P} ( z ) = {P}_{A} ( z ) \times {P}_{I} \\ where \\ {P}_{P} ( z ) = pseudo hot pin power distribution \\ \begin{matrix}{P}_{I} = planar radial peaking factor \\ = {max}_{for all x , y} {P}_{I} ( x , y )\end{matrix} \qquad ( 1 )$$

The I-th region is z_{I-1}<z≦z_{I}, z₀=0 in region 1

A current COLSS uses the signals of in-core detectors, measured in real time, as P_{A}(z) of Equation 1, and arranges the values of a planar radial peaking factor P_{I}, calculated according to the type of control rod in advance, in a table and then uses them.

Furthermore, the planar radial peaking factor is calculated using an unpenalized planar radial peaking factor (a COLSS DB constant: AB_{K,L}), control rod location-related penalty factors PF1 and PF2, and a density-dependent penalty factor.

INDEX=INDEX1_{M,L}

AB_{M,L}=AB1(INDEX)

PLRAD_{N}=AB_{M,L}·PF1·PF2 FF3·FDEN(N=1,20) (2)

where INDEX1_{M,L}=array of values of INDEX vs. M and L
AB1=unpenalized planar radial peaking factor vs. INDEX
AB_{M,L}=unpenalized planar radial peaking factor
PF1=penalty factor for out of sequence
PF2=penalty factor for CEA deviation
PF3=radial peaking factor adjustment constant
M=regulating CEA index
L=shutdown and part strength CEA index
FDEN=inlet moderator density dependent radial peaking penalty factor adjustment

The definition of the planar radial peaking factor described in the CECOR methodology is represented by the following Equation 3:

$${F}_{xy}^{ik} = {[ \frac{1 \text{-} Pin}{RPF} ]}_{ik} \times \frac{{P}_{ik}}{{\sum }_{i = 1}^{N} {P}_{ik} / N} \\ where \\ \begin{matrix}{[ \frac{1 \text{-} Pin}{RPF} ]}_{ik} = CECOR 1 \text{-} pin correlation factor ( '' 1 \text{-} pin factor '' ) \\ = ( maximum pin power in assembly i level k power in core ) \\ divided by the relative power fraction for assembly \\ i at node k\end{matrix} \qquad ( 3 )$$

$${P}_{ik} = power per unit length in assembly I at node k$$

$$N = No . of assembly bundle ( = 177 for OPR 1000 )$$

$$k = No . of axial modes ( = 51 )$$

The 1-pin factors have been stored in a CECOR Library, and are configured to be recalculated and used depending on the presence or absence of a control rod type at a corresponding axial node and the burn-up.

Furthermore, the definitions of the planewise and core planar radial peaking factors are given by the following Equations 4 and 5:

F_{xy}^{k}=maxᵢF_{xy}^{ik} (4)

F_{xy}^{core}=maxₖF_{xy}^{k} (5)

Here, _{xy} of Equation 4 has the same meaning as the PLRAD of Equation 2.

2. In-Core Detector Signal-Based Planar Radial Peaking Factor

Since it is difficult for the COLSS to make a 3D detailed calculation, a real-time in-core detector signal-based planar radial peaking factor is newly defined and a pseudo 3D calculation is attempted. That is, in order to obtain the planar radial pecking factor F_{xy}^{k} of Equation 4 directly from the real-time signals of in-core detectors (5 in the axial direction, and 45 in the radial direction), rather than using table lookup, an approximate expression is defined such that F_{xy}^{K} is calculated only for the real-time signals of the in-core detectors, as shown in the following Equation 6:

$${F}_{xy}^{K} ≅ {max}_{1 , Ndet} [ {[ \frac{1 \text{-} Pin}{RPF} ]}_{IK} \times \frac{PHI ( I , K )}{{\sum }_{ I = 1}^{Ndet} PHI ( I , K ) / N det} ] for K - 1 , 5 \\ where \\ Ndet = No . of in \text{-} core detector thimble ( = 45 for OPR 1000 ) \\ PHI ( I , K ) = assembly power in the instrumented string I level K \\ \begin{matrix} {[ \frac{1 \text{-} Pin}{RPF} ]}_{IK} = CECOR 1 \text{-} pin correlation factor ( '' 1 \text{-} pin factor '' ) \\ = ( maximum pin power in assembly I level K power \\ in core ) divided by the relative power fraction \\ for assembly I at node K\end{matrix} \qquad ( 6 )$$

When the PLRAD is defined as shown in Equation 6, the PLRAD can be calculated in real time without calculating a planar radial power distribution using CECOR coupling coefficients. Furthermore, since the center positions of in-core detectors are present at locations of 10%, 30%, 50%, 70%, and 90% in the axial direction, the PLRAD (J=1, 20) is expanded to the following Equation 7:

{PLRAD(J), J=1,4}=F_{xy}^{K} (K=1)

{PLRAD(J), J=5,8}=F_{xy}^{K} (K=2)

{PLRAD(J), J=9,12}=F_{xy}^{K} (K=3)

{PLRAD(J), J=13,16}=F_{xy}^{K} (K=4)

{PLRAD(J), J=17,20}=F_{xy}^{K} (K=5) (7)

3. Estimation of Planar Radial Peaking Factor Calculation Methodology Using In-Core Detector Signals

The ultimate object of this estimation is to show that “the pseudo hot pin power distribution methodology constructed by applying planar radial peaking factors, PLRAD (J=1,20) defined as Equations 6 and 7 appropriately estimates DNBR POL and LHR POL values at 95/95 (probability/reliability).”

In order to determine the practicability of this methodology, (a) an existing COLSS simulation code (COLSIM), (b) a code that simulates the application of the live signal based planewise Fxy methodology, that is, the present invention, into COLSIM (LIVE_COLSIM), and (c) a code that simulates the application of the CECOR methodology, described in section 2, into COLSIM were generated (SP_CCR_COLSIM), these three codes were applied to cycle of unit 3 of the Yeonggwang nuclear power plant, and then comparisons and estimations were made.

3.1 Comparisons Between Planar Radial Peaking Factors

Planar radial peaking factor application values calculated using the three codes and corresponding pseudo hot pin power distributions are compared with respect to specific burn-up (BU=0.0, 8571.0, 15481.0 [MWD/MTU]).

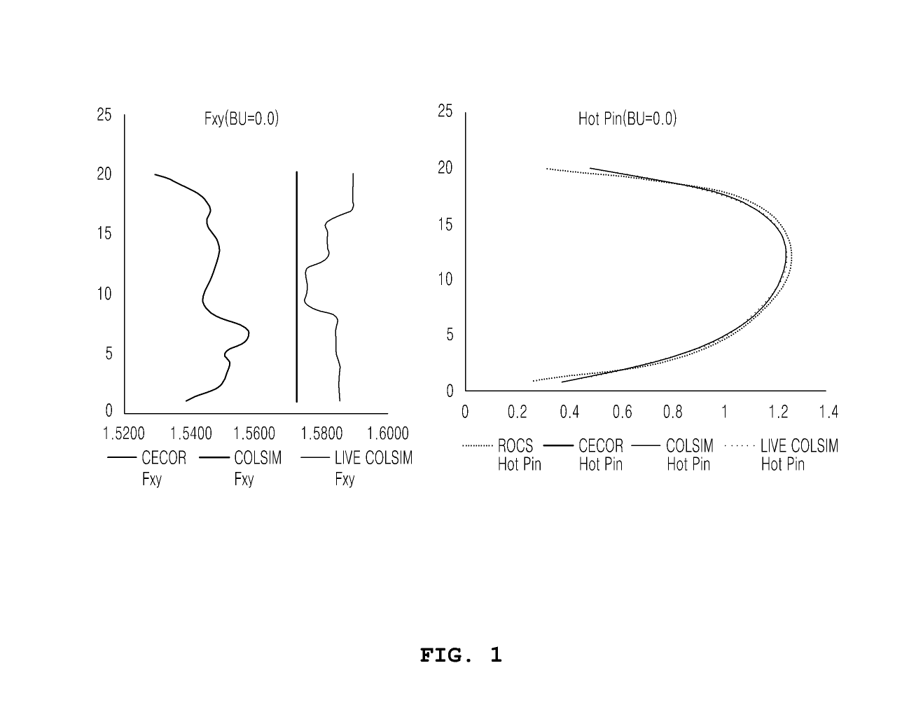

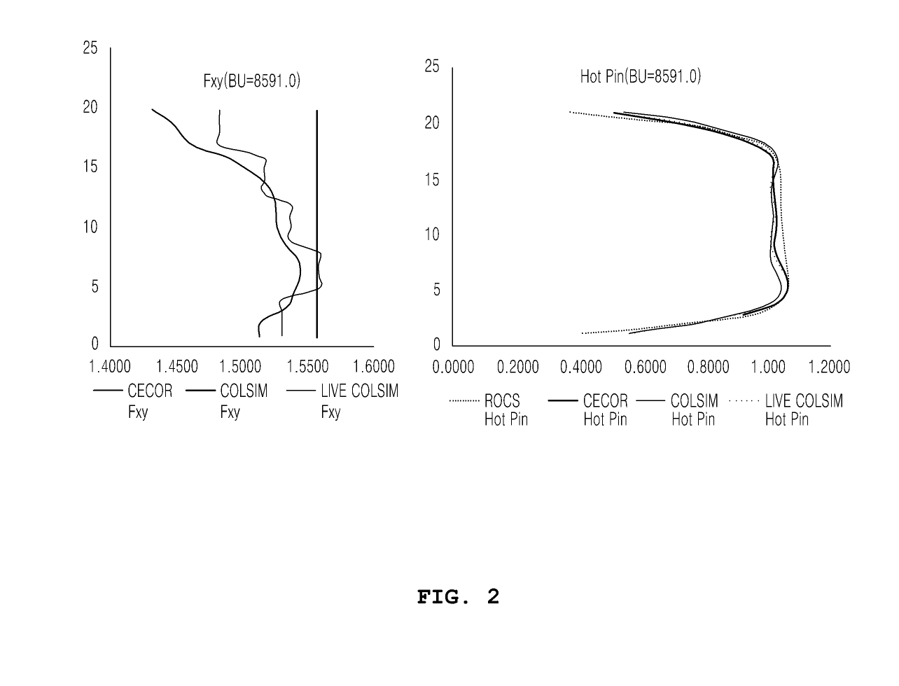

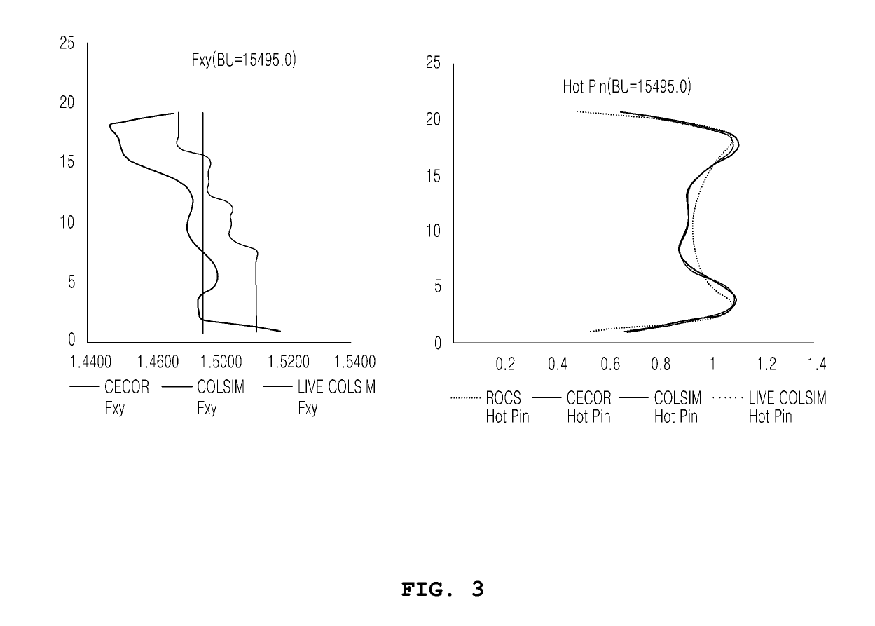

FIG. 1 is a diagram showing comparisons between planar radial peaking factor application values and pseudo hot pin power distributions when the specific burn-up BU=0.0 [MWD/MTU] (in the beginning section of a cycle), FIG. 2 is a diagram showing comparisons between planar radial peaking factor application values and pseudo hot pin power distributions when the specific burn-up BU=8571.0 [MWD/MTU] (in the middle section of the cycle), and FIG. 3 is a diagram showing comparisons between planar radial peaking factor application values and pseudo hot pin power distributions when the specific burn-up BU=15481.0 [MWD/MTU] (in the end section of the cycle).

Although the planar radial peaking factors exhibit three code results that are considerably different, as shown in FIGS. 1, 2 and 3, no great differences are exhibited when pseudo hot pin power distributions, together with axial average power distributions, are generated. Since these differences ultimately affect the determination of DNBR POL and LHRPOL values, the degrees of the differences may be determined by estimating the overall uncertainty.

3.2 Comparisons Between DNBR/LHR POL-Related Penalties

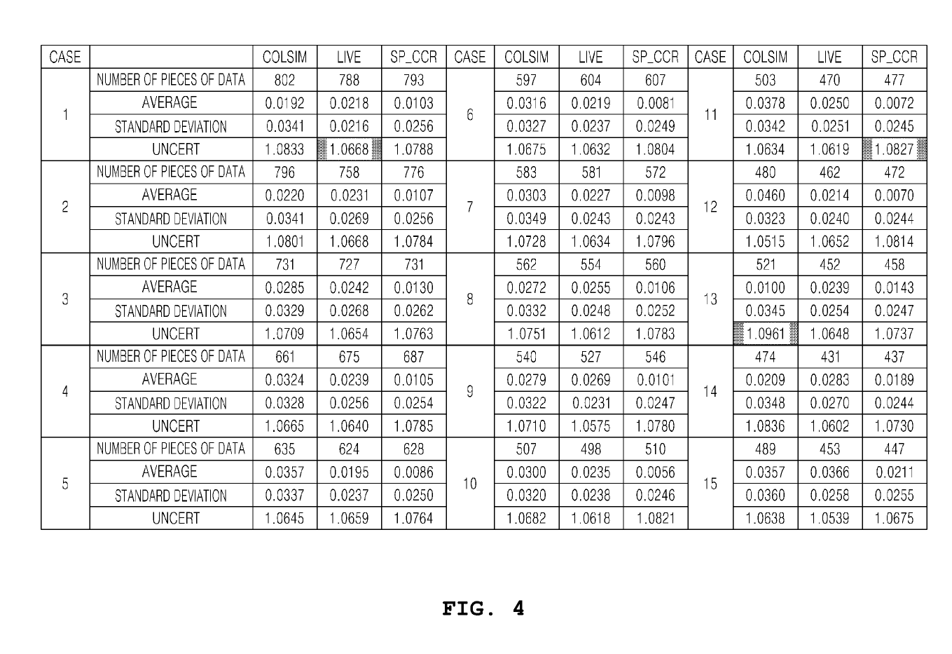

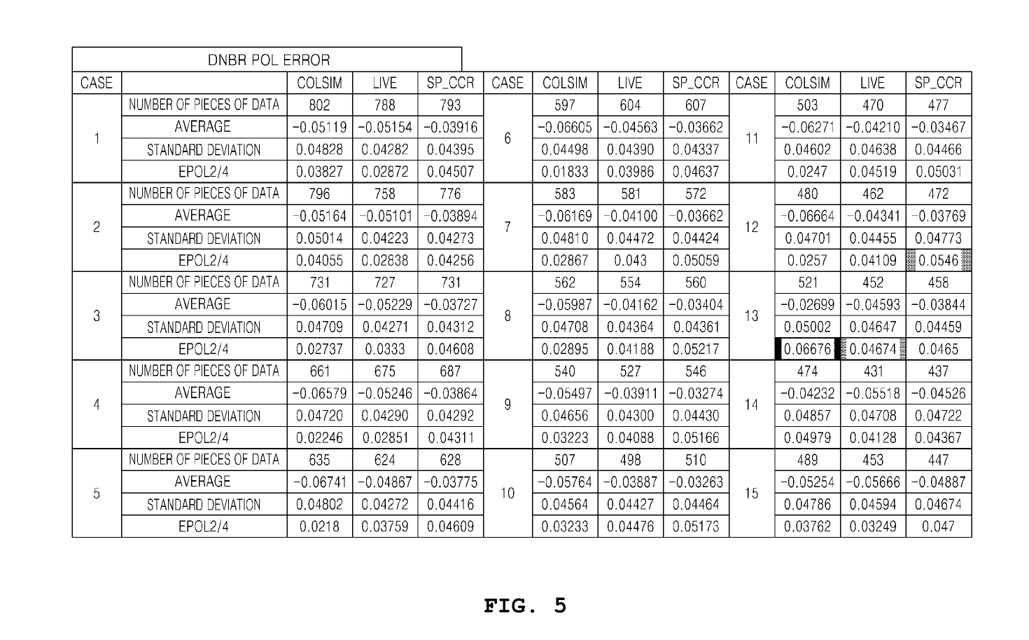

FIG. 4 is a diagram showing Fq errors calculated using three codes, that is, COLSIM, LIVE_COLSIM and SP_CCR_COLSIM, and FIG. 5 is a diagram showing DNBR POL errors calculated using three codes, that is, COLSIM, LIVE_COLSIM and SP_CCR_COLSIM.

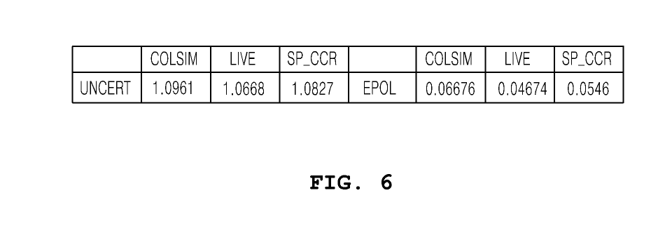

Furthermore, FIG. 6 is a diagram showing the most conservative results of UNCERT and EPOL that are obtained by the estimation of overall uncertainty.

In the case of UNCERT, the penalty in which a value based on the live Fxy methodology was smaller than that based on the existing methodology by 2.75% (=(1.0961/1.0668−1)*100) was applied. This means that the great, that is, conservative, pseudo hot pin power distribution of the live Fxy methodology was applied.

Furthermore, EPOL exhibits a slight difference between a value based on the present methodology and a value based on the existing methodology (=1.91%=(1.06676/1.04674−1)*100). Since the concept of the integration of the power distribution is applied to the calculation of the DNBR POL, the difference between the pseudo hot pin power distribution of the present methodology and that of the existing methodology can be found based on actual design materials.

The above-described uncertainty analysis is performed on the assumption that the in-core detectors “randomly fail,” like the existing COLSS overall uncertainty analysis. That is, when the integrity of the in-core detectors is suspicious, corresponding signals are deleted and then uncertainty is calculated using a smaller number of signals, as in the current procedure. In contrast, when the methodology of replacing suspicious in-core detector signals with design values is applied, there is “contradiction in the implementation of a COLSS” in which overall uncertainty decreases even though the number of in-core detectors physically decreases. However, in the present methodology, this contradiction does not fundamentally manifest itself.

3.3 Comparisons Between Thermal Margins

Although according to an actual design procedure, final variable constants would have been determined after the greatest of the raw values of the calculation of overall uncertainty had been compensated, the estimation of thermal margins was performed on the assumption that those values were final values.

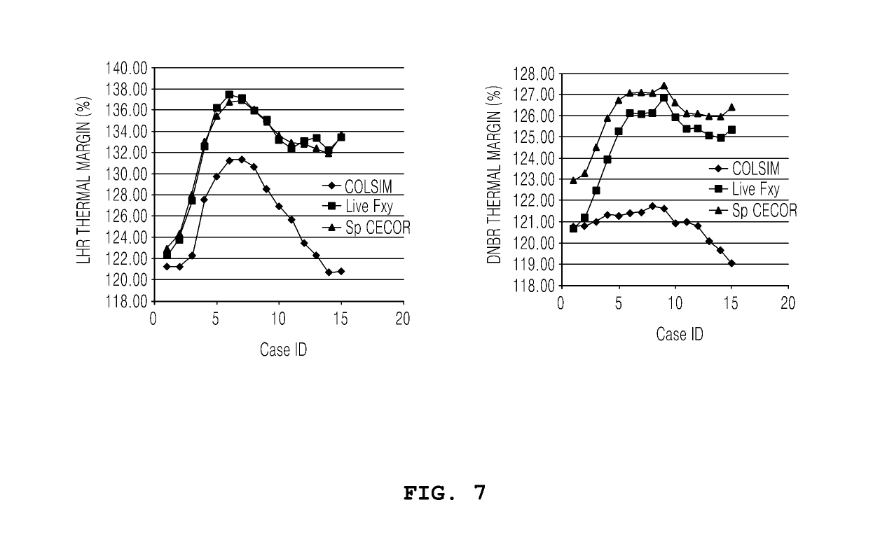

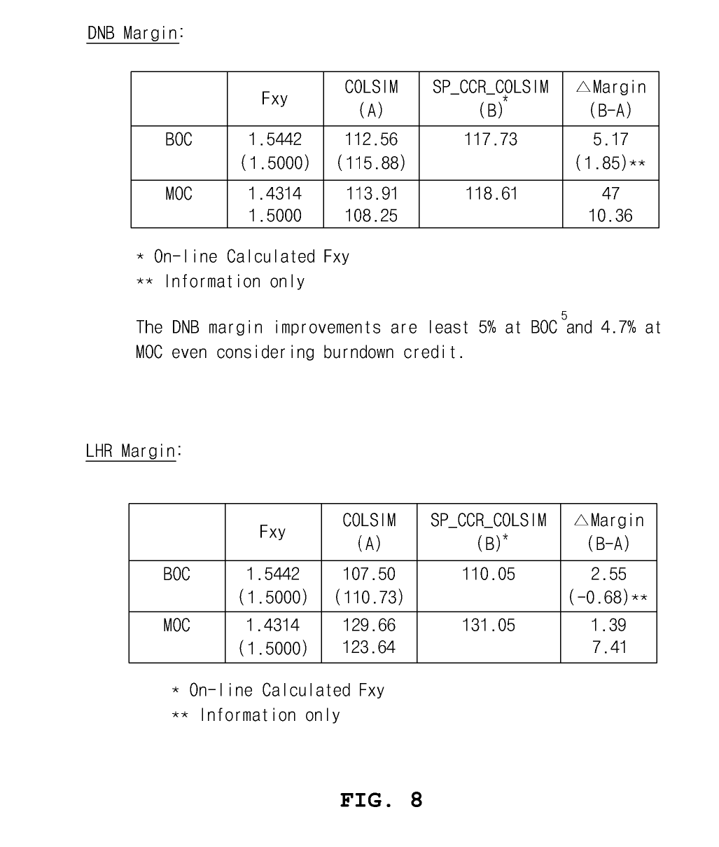

FIG. 7 is a diagram showing Y3C13 Fq and DNBR thermal margins, and FIG. 8 is a diagram showing data about comparisons between thermal margins based on the SP_CCR_COLSIM of the initial cores of units 3 and 4 of the Yeonggwang nuclear power plant based on the thermal margins shown in FIG. 7.

As a result of an analysis of cycle 13 of unit 3 of the Yeonggwang nuclear power plant, the methodology was estimated to increase the Fq thermal margin by a maximum of 10.46% and to increase the DNBR thermal margin by a maximum of 5.21%, compared to the existing methodology.

This is because in the existing methodology, the installed Fxy uses the maximum value in the cycles, whereas in this methodology, there is a large portion that automatically takes the burndown effect of the Fxy as gain.

As can be seen from the COLSIM thermal margin vs. the SP_CCR_COLSIM thermal margin in units 3 and 4 of the Yeonggwang nuclear power plant shown in FIG. 8, when the planewise Fxy was calculated directly from the original CECOR and then applied, it was estimated that the Fq thermal margin increased by a maximum of 7.41% based on the absolute value and the DNBR thermal margin increased by a maximum of 10.31% based on the absolute value. The reason why the gain of the Fq thermal margin is smaller than the DNBR gain is estimated to reside in the power distribution characteristics of initial core. It is estimated that the live Fxy methodology will exhibit a similar tendency.

Furthermore, as shown in FIG. 8, the tendencies of thermal margins of the Live Fxy methodology and the Sp CECOR methodology were estimated to be similar, which verifies that the live Fxy methodology that improves only planewise Fxy is useful. That is, it is determined that sufficient thermal margin gain will be generated by additionally taking into consideration only the peaking information of instrumented signals in the existing methodology, rather than by using a full 3-D calculation that obtains a planar radial power distribution using the coupling coefficient concept.

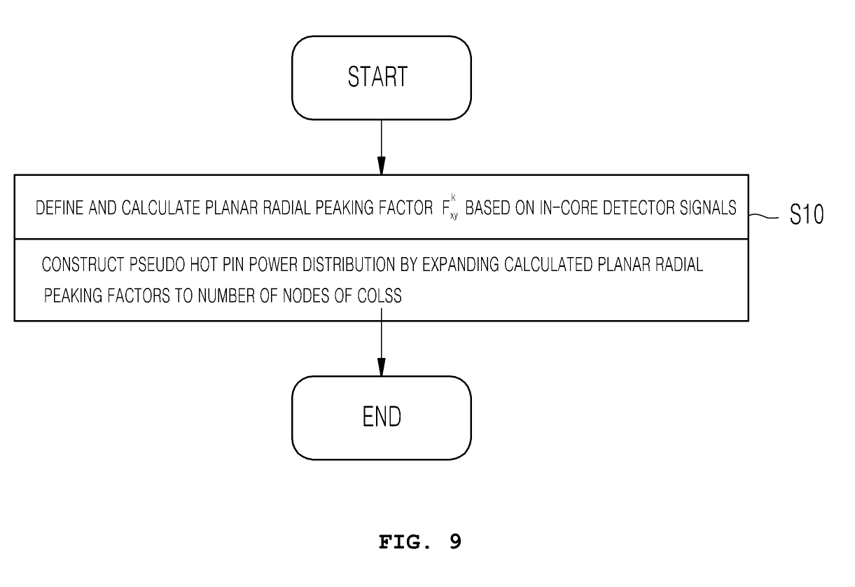

As shown in FIG. 9, the method for constructing a pseudo hot pin power distribution using in-core detector signal-based planar radial peaking factors in a COLSS according to the present invention is configured to define a planar radial peaking factor F_{xy}^{K} based on the signals of in-core detectors and expand the planar radial peaking factor F_{xy}^{K} so that the planar radial peaking factor F_{xy}^{K} is suitable for the number of nodes of the COLSS at step S10.

Here, the planar radial peaking factor F_{xy}^{K} is calculated only for the signals of the in-core detectors (five in the axial direction and 45 in the radial direction) based on Equation 6, rather than by using table lookup:

$${F}_{xy}^{K} ≅ {max}_{1 , Ndet} [ {[ \frac{1 \text{-} Pin}{RPF} ]}_{IK} \times \frac{PHI ( I , K )}{{\sum }_{ I = 1}^{Ndet} PHI ( I , K ) / N det} ] for K - 1 , 5 \\ where \\ Ndet = No . of in \text{-} core detector thimble ( = 45 for OPR 1000 ) \\ PHI ( I , K ) = assembly power in the instrumented string I level K \\ \begin{matrix} {[ \frac{1 \text{-} Pin}{RPF} ]}_{IK} = CECOR 1 \text{-} pin correlation factor ( '' 1 \text{-} pin factor '' ) \\ = ( maximum pin power in assembly I level K power \\ in core ) divided by the relative power fraction \\ for assembly I at node K\end{matrix} \qquad ( 6 )$$

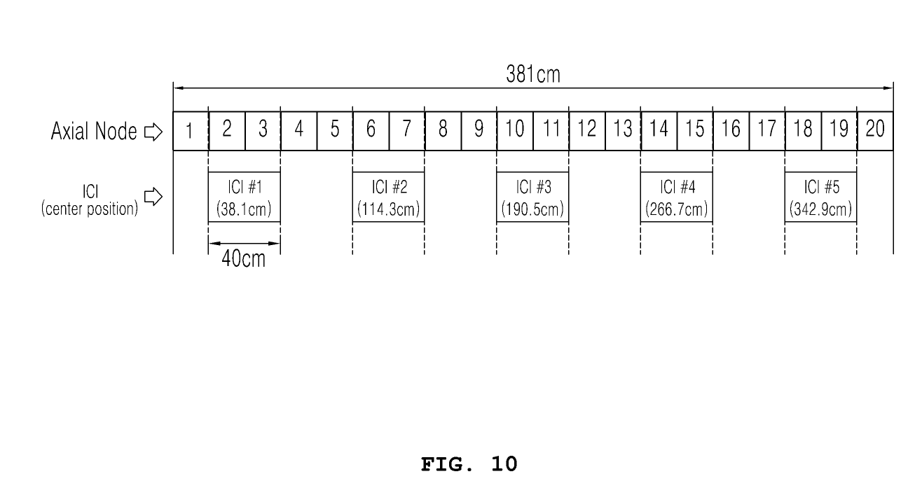

In order to apply the obtained F_{xy}^{K} to the COLSS, 20 nodes in the axial direction are required, so that the calculation of the planar radial peaking factor (planewise Fxy) is performed based on the relationships between the axial locations of the in-core detectors and the nodes of the COLSS, shown in FIG. 10, and Equation 7:

{PLRAD(J), J=1,4}=F_{xy}^{K} (K=1)

{PLRAD(J), J=5,8}=F_{xy}^{K} (K=2)

{PLRAD(J), J=9,12}=F_{xy}^{K} (K=3)

{PLRAD(J), J=13,16}=F_{xy}^{K} (K=4)

{PLRAD(J), J=17,20}=F_{xy}^{K} (K=5) (7)

As a result of the analysis of cycle 13 of unit 3 of the Yeonggwang nuclear power plant based on the above-described methodology, the pseudo hot pin power distribution calculation method of the present invention was estimated to increase the Fq thermal margin by a maximum of 10.46% and to increase the DNBR thermal margin by a maximum of 5.21%, compared to the existing methodology.

Furthermore, the tendencies of the thermal margins of the pseudo hot pin power distribution calculation method of the present invention (the live Fxy methodology) and the Sp CECOR methodology were estimated to be similar. Accordingly, it is determined that sufficient thermal margin gain will be generated by additionally taking into consideration only the peaking information of instrumented signals in the existing methodology without performing a full 3-D calculation.

The present invention provides the advantage of defining planar radial peaking factors F_{xy}^{K} based on in-core detector signals and applying the planar radial peaking factors F_{xy}^{K} to the node of a COLSS in the axial direction, thereby calculating a pseudo hot pin power distribution based on real-time signals, rather than using values given by the COLSS in advance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for constructing a pseudo hot pin power distribution using in-core detector signal-based planar radial peaking factors in a Core Operating Limit Supervisory System (COLSS), the method comprising:
defining a planar radial peaking factor F_{xy}^{K} based on in-core detector signals in the COLSS, and expanding the planar radial peaking factor F_{xy}^{K} so that the planar radial peaking factor F_{xy}^{K} is suitable for a number of nodes of the COLSS;
wherein the planar radial peaking factor F_{xy}^{K} is calculated only for the in-core detector signals using Equation 6, rather than by using table lookup:
$${F}_{xy}^{K} ≅ {max}_{1 , Ndet} [ {[ \frac{1 \text{-} Pin}{RPF} ]}_{IK} \times \frac{PHI ( I , K )}{{\sum }_{ = 1}^{Ndet} PHI ( I , K ) / N det} ] for K - 1 , 5 \\ where \\ Ndet = No . of in \text{-} core detector thimble ( = 45 for OPR 1000 ) \\ PHI ( I , K ) = assembly power in the instrumented string I level K \\ \begin{matrix} {[ \frac{1 \text{-} Pin}{RPF} ]}_{IK} = CECOR 1 \text{-} pin correlation factor ( '' 1 \text{-} pin factor '' ) \\ = ( maximum pin power in assembly I level K power \\ in core ) divided by the relative power fraction \\ for assembly I at node K\end{matrix} \qquad ( 6 )$$

2. The method of claim 1, wherein the planar radial peaking factor is calculated in real time based on relationships between axial locations of the in-core detectors and nodes of the COLSS using Equation 7:
{PLRAD(J), J=1,4}=F_{xy}^{K} (K=1)
{PLRAD(J), J=5,8}=F_{xy}^{K} (K=2)
{PLRAD(J), J=9,12}=F_{xy}^{K} (K=3)
{PLRAD(J), J=13,16}=F_{xy}^{K} (K=4)
{PLRAD(J), J=17,20}=F_{xy}^{K} (K=5) (7)
